(19) United States
(12) Patent Application Publication
(10) Pub. No.: US 2004/0132452 A1
(43) Pub. Date: Jul. 8, 2004

(54) Apparatus and method for establishing a session in a radio network organized with mobile nodes

(76) Inventor: Dong-Hee Lee, Ansan-si (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/740,894

(22) Filed: Dec. 22, 2003

(30) Foreign Application Priority Data
Dec. 30, 2002 (KR) 2002-86856

(51) Int. Cl. H04Q 7/20

(52) U.S. Cl. 455/445

(57) ABSTRACT

Apparatus and method for establishing a session in a radio network organized with mobile nodes. If a source mobile node requests a session setup from the destination mobile node and a distance between the transmission and destination mobile nodes is longer than a predetermined distance, the apparatus uses message relay mobile nodes. The source mobile node transmits a session setup request message to the destination mobile node via the message relay mobile nodes. Message transmission time information between mobile nodes is detected by individual mobile nodes and is stored in the same. The received session setup request message is stored in individual mobile nodes. Therefore, if all the mobile nodes transmit their session setup request messages to neighboring mobile nodes and there is no response to the transmitted session setup request messages, the mobile nodes retransmits the stored session setup request message.

### PRIORITY

This application claims priority to an application entitled “APPARATUS AND METHOD FOR ESTABLISHING SESSION IN RADIO NETWORK ORGANIZED WITH MOBILE NODES”, filed in the Korean Intellectual Property Office on Dec. 30, 2002 and assigned Ser. No. 2002-86856, the contents of which are incorporated herein by reference.

### BACKGROUND OF THE INVENTION 1. Field of the Invention

The present invention relates to a signaling apparatus and method for providing a user or subscriber with a Voice over Internet Protocol (VoIP) service, and more particularly to an apparatus and method for providing a Session Initiation Protocol (SIP) signaling message that provides a user with a SIP-based VoIP service in a radio network (i.e., a wireless network) composed of only terminals, i.e., a Mobile Ad-hoc Network (MANET). 2. Description of the Related Art

Typically, a VoIP service technique has been widely used to provide, in real time, a user or subscriber with voice, data, and video communication services. The VoIP service technique can reduce usage fees for a communication service by efficiently employing a typical network resource, and can be easily administered by unifying a telephone network e.g., a Public Switched Telephone Network (PSTN) and a data network e.g., a Public Switched Data Network (PSDN) into one network. Many developers have conducted intensive research into the VoIP service technique serving as a major focus of next generation communication architectures. Voice communication technologies that provide service over the Internet instead of over a PSTN are rapidly being developed. A software program for use with an Internet Phone was developed by Vocaltec Communications Ltd. on Feb. 2, 1995. This software program is generally called a Personal Computer (PC)-to-PC model that compresses voice signals for transmission from a transmitting or receiving user's PC composed of a sound card, speaker, microphone, and modem (or network card), etc. The transmitting or receiving user installs the software program on his or her PC, converts the compressed voice signal into IP packets, and transmits the IP packets over the Internet such that a call connection state between the transmitting and receiving users is established over the Internet. The signaling methods (i.e., a method for processing a message associated with a session setup function) developed for such Internet phone services have been designed based on wired/wireless mobile communication networks, and a system for such a signaling method is composed of a terminal, a server for user registration, and the other server for a call setup operation, etc.

Typically, users register a user ID in the server for user registration using their terminals for use in the Internet Phone service, and perform call termination or call origination functions using the server. A representative example of Internet phone services is Internet Engineering Task Force (IETF) SIP technology. The SIP is adapted to define a procedure of the Internet phone service, associated information, and associated equipment such as a server. The SIP technology is designed based on a reliable wired network, performs transmission acknowledgement and retransmission of the signaling message using an acknowledgement message to guarantee reliability of the signaling message transmission, and uses a signalized protocol instead of using an H.323/H.245 protocol. The SIP protocol controls a proxy server, a location registration server, a redirection server, etc., to be arranged in the network in order to perform a signaling switching function, and thus performs an address interpretation, a user-location tracking service, and a signaling message router function, etc.

The proxy servers can provide users with a plurality of communication services, for example, an incoming call generation and a response or non-response to the incoming call; an incoming call generation in a call connection state; a Call Forwarding Unconditional (CFU) service; a negotiation service for terminal accommodation; and a requester user and the user's colleague, etc.

FIG. 1 is a block diagram illustrating an example of a network configuration of a conventional MANET composed of only mobile nodes. Each mobile node shown in FIG. 1 may include a Personal Digital Assistant (PDA), a smart phone, or a typical mobile element, etc. The MANET shown in FIG. 1 is composed only of User Equipments (UE's). In the case of a typical wireless mobile communication service, a communication service between UEs is established or performed using a Node B, and a Radio Network Controller (RNC), etc. However, a new method for controlling one UE to directly communicate with a nearby UE without using the Node B or the RNC, etc., is needed, such that a new type of MANET is developed.

Nine mobile nodes composed of six termination mobile nodes 100, 102, 104, 106, 108, and 110 and three message relay mobile nodes 112, 114, and 116 are shown in FIG. 1. If a communication service between the termination mobile nodes 100-110 is requested, a distance between the termination mobile nodes 100-110 may be longer than a predetermined distance. If the distance between the termination mobile nodes 100-110 is longer than the predetermined distance, it is difficult for the termination mobile nodes 100-110 to directly communicate with each other. In this case, mobile nodes located between the termination mobile nodes 100-110 are mobile nodes serving as repeaters. That is, the mobile nodes are also called message relay mobile nodes 112-116. Of course, if the termination mobile nodes 100-110 are adjacent to each other, a communication service is made available without using the message relay mobile nodes 112-116.

The MANET is a network concentrated on not only a large-scale communication network service such as an Internet service but also a communication service between nodes when a process for creating an infra-structure having a plurality of nodes (i.e., a Node B, and an RNC, etc.) is not cost-effective or has difficulty in its physical implementation. Individual nodes contained in the MANET have no limitations in their range of movement, but they have limitations in amounts of resource and power use, such that a routing protocol cannot be made available for a typical wired network. The routing protocol is classified into a reactive routing protocol and a proactive routing protocol. For the reactive routing protocol, individual mobile nodes search for the shortest transmission path using a control message before transmitting desired data, and transmit the desired data over the found shortest transmission path. For the proactive routing protocol, mobile nodes periodically transmit the control message. Therefore, since the mobile nodes can recognize distance information between one mobile node and the other mobile node, they can immediately transmit data over the shortest path. The mobile node performs data transmission/reception functions while in motion, and at the same time serves as a router for the other mobile node, resulting in increased energy consumption. If the other mobile node transmits large amounts of data, the mobile node serves as a message relay mobile node, resulting in increased energy consumption. The mobile nodes use their on-board batteries, respectively, such that their operations may be unexpectedly interrupted due to power consumption of the batteries. Therefore, a network structure for a routing function requisite for packet transmission can be changeable in the MANET. If one mobile node from among the mobile nodes is out of range of radio propagation, the out of range mobile node also is also out of range from the MANET. Therefore, an access or connection state of the out of range mobile node is unexpectedly cleared. Although the MANET has the aforementioned disadvantages, it can freely construct a network system and can also be freely installed anywhere a user wishes, such that the MANET has become increasingly popular as the next generation communication network. If an emergency incident where a typical system becomes unavailable occurs, the MANET can be efficiently used for the emergency incident.

FIG. 2 is a flow chart illustrating a session setup procedure in the MANET based on a SIP for use in the Internet phone service. The session setup procedure in the MANET will hereinafter be described with reference to FIG. 2. It should be noted that the MANET has no server, addresses of mobile nodes (i.e., first mobile nodes) must be stored in second other mobile nodes (i.e., second mobile nodes), and a session setup procedure must be established in the direction from a source mobile node to a destination mobile node.

Referring to FIG. 2, the source mobile node attempts to perform a session setup operation in order to communicate with the destination mobile node. If the distance from the source mobile node to the destination mobile node is longer than a predetermined distance, the source mobile node communicates with the destination mobile node using the message relay mobile nodes.

A source mobile node 200 transmits a session setup request message to its surrounding mobile nodes in order to request a session setup from a destination mobile node 206 at step 210. An IP address of the destination mobile node 206 is transmitted to the surrounding mobile nodes of the source mobile node 200. It should be noted that the session setup request message includes not only IP address information of the destination mobile node 206 but also session setup trial information for the destination mobile node 206.

The message relay mobile node 202 compares its own IP address with the IP address received from the source mobile node at step 212. If the IP address of the message relay mobile node 202 is equal to the IP address received from the source mobile node, this indicates that the source mobile node 200 is a mobile node for requesting the session setup. However, referring to FIG. 2, the IP address of the message relay mobile node 202 is different from the IP address of the mobile node requesting the session setup. Therefore, the message relay mobile node 202 transmits a session setup request message for the destination mobile node 206 to its nearby mobile nodes.

A message relay mobile node 204 receives the destination mobile node 206's IP address from the message relay mobile node 202 at step 214. Operations of the message relay mobile node 204 at step 214 are the same as those of the message relay mobile node 202 at step 212.

The destination mobile node 206 compares at step 216 its own IP address with the destination mobile node 206's IP address transferred from the message relay mobile node 204 at step 214. Upon receiving the result of the comparison, it can be recognized that the source mobile node 200 serves as a mobile node for requesting the session setup. Therefore, the destination mobile node 206 transmits a permission message associated with the session setup request of the source mobile node 200. The destination mobile node 206 cannot directly transmit a session setup request permission message to the source mobile node 200, such that it transmits it to the source mobile node 200 over the message relay mobile node 204. Therefore, the destination mobile node 206 can transmit a session setup request permission message to the message relay mobile node 204.

The message relay mobile node 204 receives the session setup request permission message from the destination mobile node 206, and transmits it to the message relay mobile node 202 at step 218. The message relay mobile node 202 transmits the session setup request permission message received from the message relay mobile node 204 to the source mobile node 200 at step 220. By means of the above steps 210 to 220, a session between the source mobile node and the destination mobile node 206 can be established. A session setup between the source mobile node 200 and the destination mobile node 206 is completed at step 224.

The session setup request message contains only an IP address of the destination mobile node, and does not contain any message other than the destination mobile node's IP address. If the session setup request message is transmitted from one message relay mobile node to the other message relay mobile node in the MANET, or is transmitted from the message relay mobile node to the destination mobile node in the MANET, undesired errors may occur. If the session setup request permission message is transmitted from one mobile node to the other mobile node, undesired errors may also occur. In this case, the source mobile node cannot recognize a signal transmission state of either the session setup request message or the session setup permission message, such that it waits for a session setup request response message for a predetermined period of time denoted by “Tg” in FIG. 2. Thus, at step 222, a retransmission determination is performed. Specifically, provided that errors occur at steps 210-220 before the lapse of the predetermined time “Tg” and thus the session setup request permission message is not received in the source mobile node, the source mobile node retransmits the session setup request message even though FIG. 2 shows a normal reception mode of the session setup request permission message.

In other words, the wireless link is significantly affected by the wireless communication environment, such that its transmission state may abruptly vary with the environment in which a MANET is used, or a signal transmission time. Therefore, the higher the probability of errors in a typical SIP-based MANET, the longer the session-setup consumption time. As stated above, the source mobile node can determine whether the session setup process associated with the destination mobile node fails or not after the lapse of a predetermined period of time. Provided that the predetermined period of time does not elapse, the source mobile node cannot determine whether the session setup process associated with the destination mobile node has failed or not. In conclusion, an improved method for quickly determining a signal retransmission command by recognizing success or failure of the session setup procedure before the lapse of a predetermined period of time needs to be developed.

### SUMMARY OF THE INVENTION

Therefore, it is an object of the present invention to provide an apparatus and method for quickly recognizing errors unexpectedly incurred during a session setup procedure when a session between the source mobile node and the destination mobile node is established.

It is another object of the present invention to provide an apparatus and method for enabling a message relay mobile node to recover from errors created during a session setup time between the transmission and destination mobile nodes.

It is yet another object of the present invention to provide an apparatus and method for quickly recognizing errors created during the session setup time, and quickly performing a session setup process upon receiving the recognized result.

It is yet a further another object of the present invention to provide an apparatus and method for reducing the number of signal retransmission times between the source mobile node and the destination mobile node, and re-transmitting signals in link units.

In accordance with one aspect of the present invention, the above and other objects can be substantially accomplished by the provision of a method for controlling a source mobile node to establish a session to a destination mobile node via message relay mobile nodes in a radio network comprised of the source mobile node, the destination mobile node, and one or more message relay mobile nodes. The method may comprise the steps of (a) creating a session setup request message to be transmitted to the destination mobile node, storing the created session setup request message, and at the same time transmitting the created session setup request message to one message relay mobile node from among the message relay mobile nodes; and (b) if a session setup permission standby message corresponding to the session setup request message is not received from the message relay mobile node having transmitted the session setup request message before a predetermined link retransmission time elapses, re-transmitting the stored session setup request message.

In accordance with another aspect of the present invention, there is provided a method for controlling message relay mobile nodes to route a session setup state in a direction from a source mobile node to the destination mobile node at which a session setup request is to be transmitted, in a radio network comprised of the source mobile node, the destination mobile node, and one or more message relay mobile nodes. The method may comprise the steps of (a) storing the received session setup request message, and transmitting the stored session setup request message to either the message relay mobile node or the destination mobile node; and (b) if a session setup permission standby message corresponding to the session setup request message is not received from the mobile node having transmitted the session setup request message before a predetermined link retransmission time elapses, re-transmitting the stored session setup request message.

In accordance with yet another aspect of the present invention, there is provided an apparatus for establishing a session from a source mobile node to a destination mobile node via message relay mobile nodes in a radio network comprised of the source mobile node, the destination mobile node, and one or more message relay mobile nodes. The apparatus may comprise a source mobile node for storing a session setup request message simultaneously transmitting it to the message relay mobile node, and re-transmitting the stored session setup request message when a session setup permission standby message associated with the transmitted session setup request message is not received before a predetermined link retransmission time elapses; one or more message relay mobile nodes for transmitting a session setup permission standby message to a mobile node having transmitted the session setup request message, transmitting the received session setup request message to another message relay mobile node or the destination mobile node, and re-transmitting the stored session setup request message when a session setup permission standby message associated with the session setup request message is not received before a predetermined link retransmission time elapses; and a destination mobile node for transmitting the session setup permission standby message associated with the received session setup request message.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram illustrating an example of a conventional Mobile Ad-hoc Network (MANET) system;

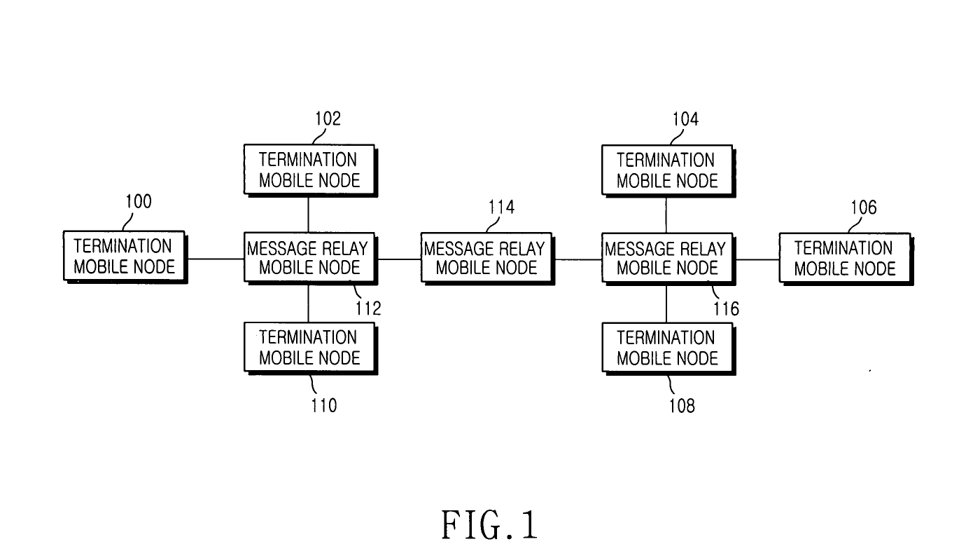

FIG. 2 is a flow chart illustrating an example of a session setup procedure for use in the conventional MANET system shown in FIG. 1;

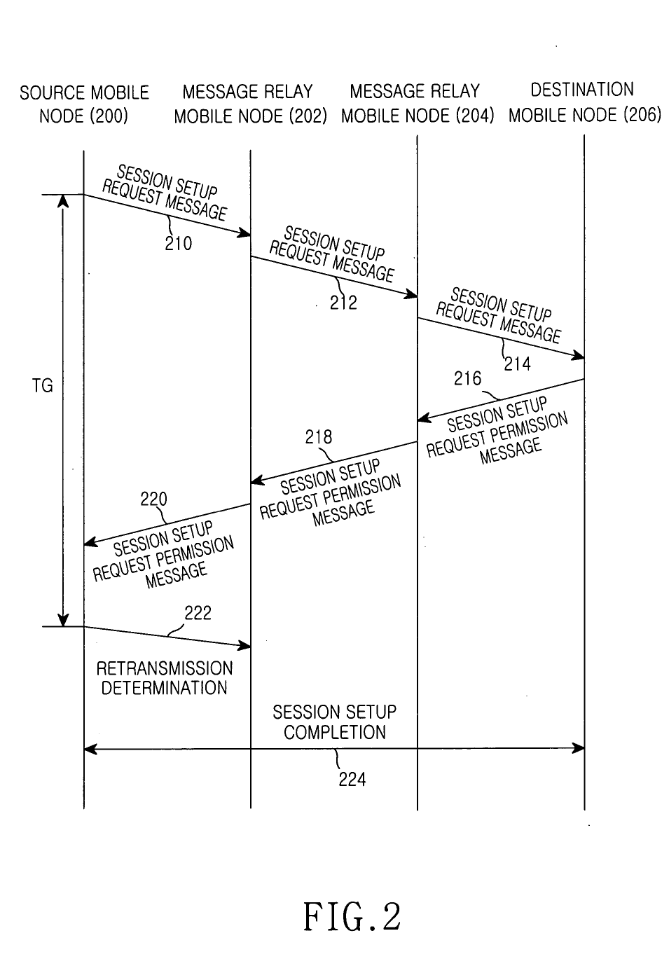

FIG. 3 is a block diagram illustrating an example of a hierarchical structure of mobile nodes in accordance with an embodiment of the present invention;

FIG. 4 is a flow chart illustrating an example of a session setup procedure for use in a source mobile node in accordance with an embodiment of the present invention;

FIG. 5 is a flow chart illustrating an example of a session setup procedure between a message relay mobile node and a destination mobile node in accordance with an embodiment of the present invention; and

FIG. 6 is a flow chart illustrating an example of a session setup procedure among the source mobile node, the message relay mobile nodes, and the destination mobile node in accordance with an embodiment of the present invention.

### DETAILED DESCRIPTION OF THE PREFERRED EMBODIMENTS

Embodiments of the present invention will be described in detail with reference to the accompanying drawings. In the drawings, the same or similar elements are denoted by the same reference numerals. In the following description, a detailed description of known functions and configurations incorporated herein will be omitted for conciseness.

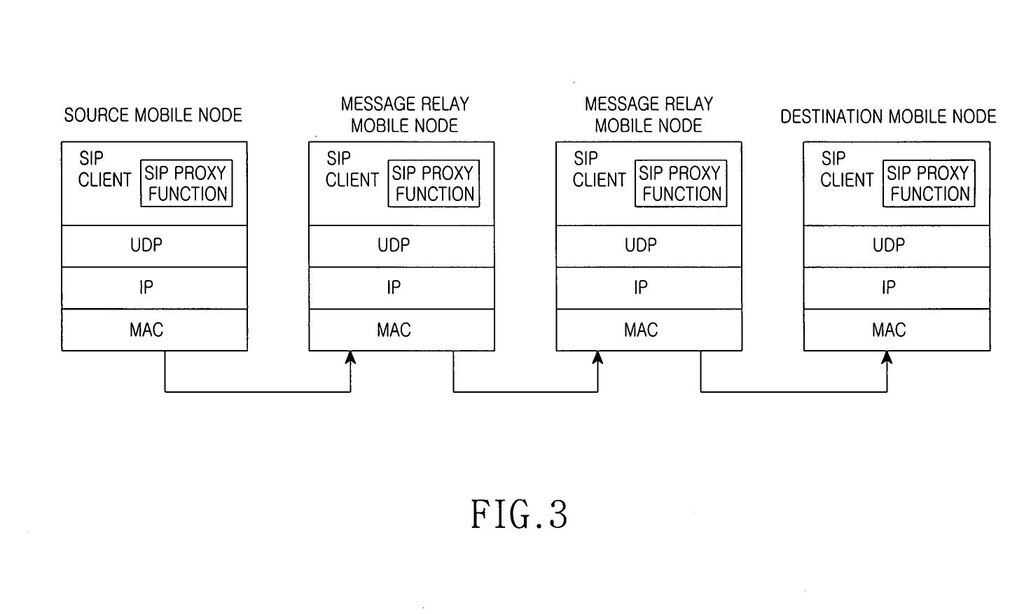

FIG. 3 is a block diagram illustrating an example of a hierarchical structure (i.e., a layered structure) of mobile nodes in accordance with an embodiment of the present invention, where several layers are contained in the hierarchical structure. The hierarchical structure, a Session Initiation Protocol (SIP) client and SIP proxy function positioned in an upper layer from among several layers, and a plurality of functions executed in individual layers of the mobile node will be described with reference to FIG. 3.

Referring to FIG. 3, the mobile node is composed of a source mobile node, message relay mobile nodes, and a destination mobile node, but these mobile nodes each have the same structure. That is, the mobile nodes are each composed of four layers, i.e., first to fourth layers. The first layer is composed of a Medium Access Control Address (MAC) layer, the second layer is composed of an Internet Protocol (IP) layer, the third layer is composed of a User Data Protocol (UDP) layer, and the fourth layer is composed of an SIP client. The IP layer compares its own Identifier (ID) with the received session setup request ID, and determines whether data transmission errors occur. The UDP layer determines whether a transmission error occurs in transmitting the session setup request message. That is, the proxy function is adapted to manage a signaling message transmission function, and performs necessary operations when the mobile node is positioned on a routing path. According to an embodiment of the present invention, the SIP client performs caching of the received signaling message such that it can transmit link-unit data, can acknowledge transmission of the link-unit data, and can retransmit the same data if needed. In other words, the conventional SIP client can perform only a session setup request function and a response function to the session setup request. However, the SIP client associated with the present invention can perform the same functions as the conventional SIP client, and at the same time can store the session setup request message therein.

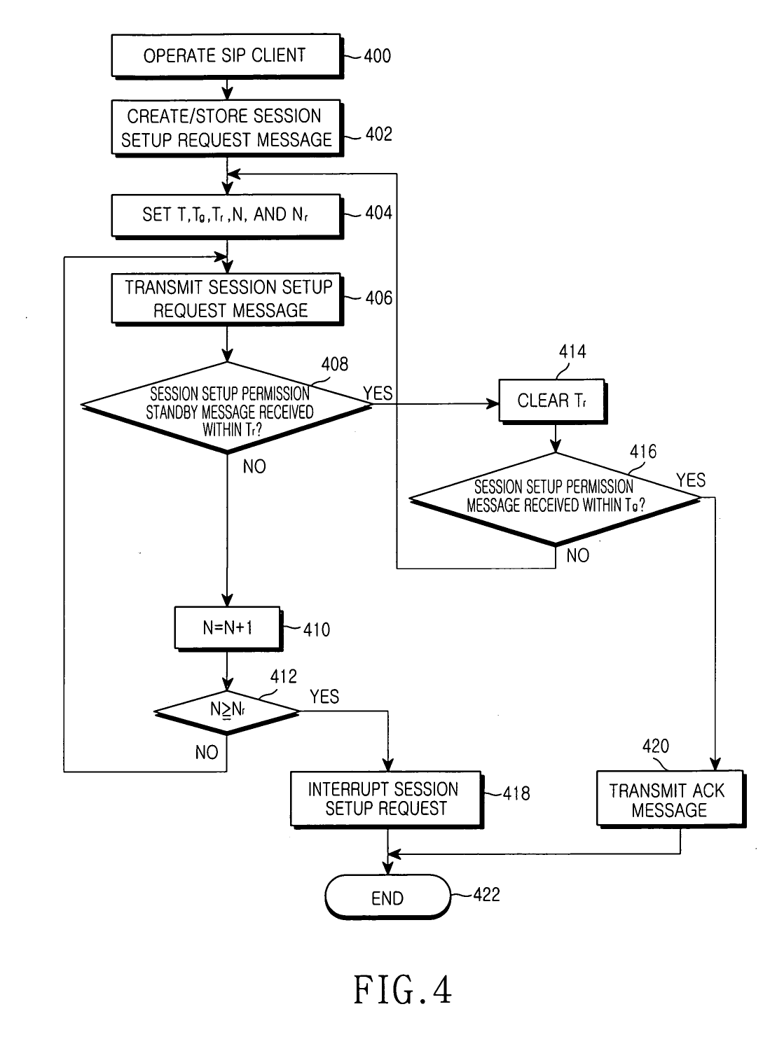

The SIP client of the source mobile node creates the session setup request message to establish a session to the destination mobile node, and transmits the created session setup request message to the message relay mobile node. The message relay mobile node determines whether a mobile node requested by the session setup request message is the message relay mobile node itself. If it is determined that the requested mobile node is not the message relay mobile node, the message relay mobile node stores the session setup request message for retransmission of the session setup request message. Simultaneously with storing session setup request message in the message relay mobile node, the session setup request message is transmitted to a nearby mobile node of the message relay mobile nodes. If an error occurs in the transmission procedure, the message relay mobile node performs data retransmission using the stored session setup request message in such a way that the session setup request message is transmitted to the destination mobile node. A detailed description of the above procedures will hereinafter be described with reference to FIGS. 4, 5, and 6.

FIG. 4 is a flow chart illustrating an example of a session setup procedure for use in a source mobile node in accordance with an embodiment of the present invention. A variety of messages are shown in FIG. 4, i.e., a session setup request message, a session setup permission standby message, a session setup permission message, and an acknowledgment (ACK) message.

The session setup request message is adapted to enable an SIP client of the source mobile node to request a session setup function from an SIP client of the destination mobile node.

The session setup permission standby message controls the proxy server to inform the SIP client of either the source mobile node or the message relay mobile node of a prescribed transmission/reception state. For the prescribed transmission/reception state, the proxy server receives the session setup request message of the SIP client contained in the transmission or message relay mobile node, the session setup request message is transmitted to either the destination mobile node or another message relay mobile node in order to perform a current session setup, and the proxy server waits for a response to the session setup request message.

The session setup permission message controls the SIP client of the destination mobile node to receive the session setup request message, and informs the SIP client of the source mobile node of session setup request permission.

The acknowledgement (ACK) message controls the source mobile node receiving the session setup permission message to inform the destination mobile node of a session setup permission message reception state.

The source mobile node starts operations of its own SIP client at step 400. The SIP client includes a variety of functions, i.e., the session setup request function, the session setup request message caching function, and the response function to the session setup request.

The source mobile node creates the session setup request message to be transmitted to the destination mobile node functioning as a session setup target at step 402. The session setup request message may include an IP address of the source mobile node requesting the session setup, an IP address of the destination mobile node, and specific information for commanding the destination mobile node to inform the source mobile node of permission or non-permission of the session setup request, etc. The source mobile node stores the session setup request message to properly cope with a retransmission mode for requesting retransmission of the created session setup request message. Table 1 shows exemplary IDs of the source mobile node, the message relay mobile nodes, and the destination mobile node.

TABLE 1

| Mobile Node | Ip address |
|---|---|
| Source mobile node | xxx.yyy.mnc111.mcc450.gprs |
| Message relay mobile node | xxx.yyy.mnc222.mcc460.gprs |
| Message relay mobile node | xxx.yyy.mnc333.mcc470.gprs |
| Destination mobile node | xxx.yyy.mnc444.mcc480.gprs |

The source mobile node determines parameter values at step 404. There are a variety of parameters, for example, a transmission timer parameter ‘T’, a global retransmission timer parameter ‘Tg’ for indicating a retransmission period caused by errors created between the transmission and destination mobile nodes, a link retransmission timer parameter ‘Tr’ for indicating a retransmission period caused by errors created between mobile nodes, the number ‘N’ of transmission or retransmission times, and a maximum number ‘Nr’ of transmission times for indicating a maximum number of transmission or retransmission times. The global retransmission timer parameter ‘Tg’ is adapted to calculate aRound Trip Time (RTT) between the source mobile node and the destination mobile node, and is typically set to a predetermined value corresponding to about 1.5 times the calculated value. The link retransmission timer parameter ‘Tr’ can be variably determined based on a distance between mobile nodes, but it is typically set to the same value.

If the session setup permission message is not transmitted to the source mobile node until the global retransmission timer consumes a predetermined period of time, the source mobile node determines that an error has occurred in the session setup request message. Therefore, the source mobile node retransmits the stored session setup request message. In this case, the session setup request message first transferred from the source mobile node may overlap with the next session setup request message transferred from the source mobile node after the lapse of a predetermined time in the global retransmission timer, such that a specific message relay mobile node may need to control/manage at least two or more session setup request messages. The session setup request message is deleted when the number of retransmission times is higher than a predetermined number of times, such that the aforesaid disadvantage where the specific message relay mobile node must control/manage at least two or more session setup request messages can be solved. The maximum number Nr of transmission and retransmission times can be denoted by a predetermined equation “Nr=0.5RTT/TR”.

The source mobile node transmits the session setup request message created at step 402 to a nearby mobile node at step 406, and at the same time operates a timer T on the basis of a transmission time of the session setup request message. The session setup request message contains information indicating the number of transmission or retransmission times. Because a transmission mode of the session setup request message is an initial transmission mode, the number of transmission/retransmission times is set to ‘1’.

It is determined at step 408 whether the source mobile node has received a session setup permission standby message before the link retransmission timer is expired. If the session setup permission standby message is not transmitted to the source mobile node before the link retransmission timer is expired, the source mobile node determines that undesired errors have occurred during a transmission time of the session setup request message. If the session setup permission standby message is not transmitted to the source mobile node before the link retransmission timer is expired at step 408, the source mobile node goes to step 410. Otherwise, if the session setup permission standby message is transmitted to the source mobile node before the link transmission timer is expired at step 408, the source mobile node goes to step 414.

The source mobile node increases a counted number of transmission/retransmission times by one in order to retransmit the session setup request message stored in the SIP client at step 410, and then goes to step 412.

The source mobile node compares the increased number of transmission/retransmission times with the maximum number of transmission times at step 412. If the increased number of transmission/retransmission times is less than the maximum number of transmission times at step 412, the source mobile node returns to step 406 to transmit the stored session setup request message. Otherwise, if the increased number of transmission/retransmission times is the same or higher than the maximum number of transmission times at step 412, the source mobile node returns to step 418. The source mobile node interrupts such a session setup request operation at step 418. Provided that an error occurs in all the session setup requests even though the number of session setup request repeating times is higher than a predetermined number of times, it is preferable for the source mobile node to perform such a session setup request operation via another path other than an erroneous path when the number of session setup request times is higher than a predetermined number of times and undesired errors occur in all the requested sessions, such that the source mobile node interrupts such a session setup request operation at step 418, and goes to step 422 to terminate the session setup procedure shown in FIG. 4.

The source mobile node clears at step 414 the link retransmission timer information that was determined at step 404. However, the procedure for clearing the link retransmission timer information may be made unavailable upon receiving a predetermined signal from a user.

It is determined at step 416 whether the source mobile node has received the session setup permission message before the global retransmission timer is expired. If the session setup permission message is not transmitted to the source mobile node before the global retransmission timer is expired, the source mobile node determines that undesired errors have occurred while transmitting the session setup request message to the destination mobile node. If the session setup permission message is not transmitted to the source mobile node before the global retransmission timer is expired, the source mobile node returns to step 404. However, if the session setup permission message is transmitted to the source mobile node before the global retransmission timer is expired, the source mobile node goes to step 420. The source mobile node transmits an ACK message to the destination mobile node at step 420, and goes to step 422 to terminate the above session setup procedure.

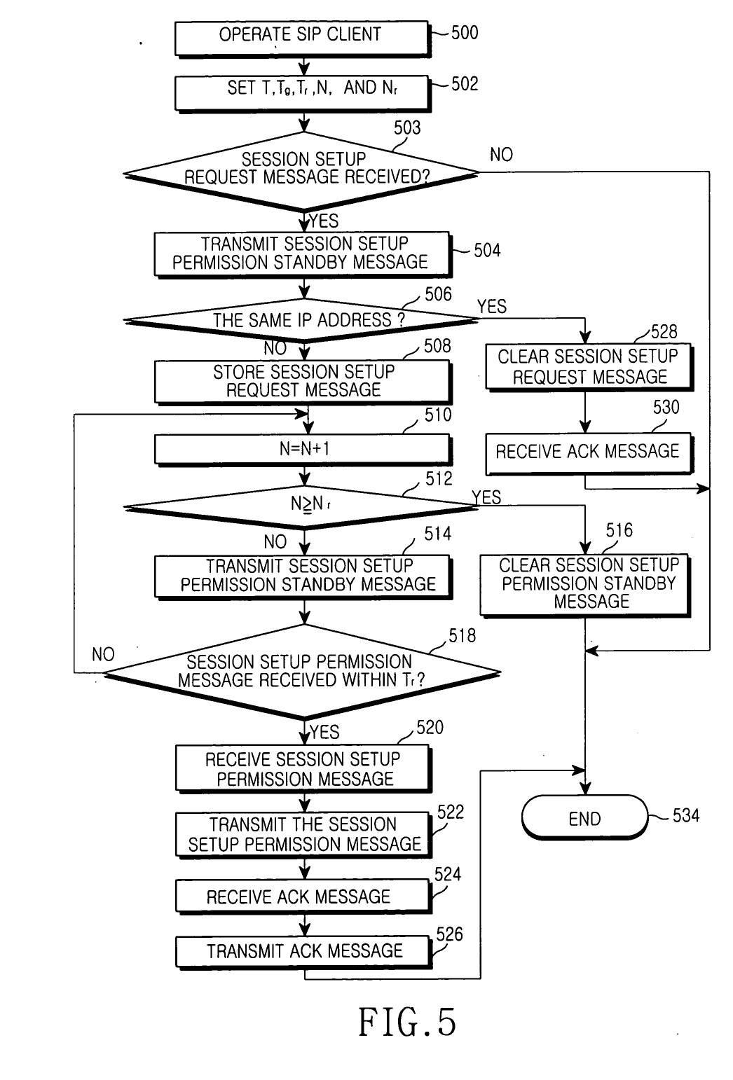

FIG. 5 is a flow chart illustrating an example of a session setup procedure between a message relay mobile node and a destination mobile node upon receiving a session setup request from the source mobile node. The message relay mobile node and the destination mobile node will collectively be referred to hereinafter only as a mobile node.

The mobile node performs substantially the same operation as in the source mobile node at step 500. In this case, the operation of the mobile node at step 500 is substantially the same as that the source mobile node at step 400. The SIP client includes a variety of functions, i.e., the session setup request function, the session setup request message caching function, and the response function to the session setup request.

The mobile node determines parameter values at step 502. There are a variety of parameters, for example, a transmission timer parameter ‘T’, a link retransmission timer parameter ‘Tr’ for indicating a retransmission period caused by errors created between mobile nodes, the number ‘N’ of transmission/ or retransmission times, and a maximum number ‘Nr’ of transmission times for indicating a maximum number of transmission or retransmission times. The link retransmission timer parameter ‘Tr’ can be variably determined with a distance between mobile nodes, but it is typically set to the same value. Therefore, typically, the link retransmission timer parameter ‘Tr’ shown in FIG. 5 is the same as that of FIG. 4. The maximum number ‘Nr’ of transmission or retransmission times shown in FIG. 5 is also the same as that of FIG. 4. Therefore, the maximum number of transmission times and the maximum number of retransmission times can be contained in the session setup request message transferred from the source mobile node.

It is determined at step 503 whether the mobile node has received the session setup request message. If the mobile node has received the session setup request message at step 503, it goes to step 504. Otherwise, if the session setup request message is not transmitted to the mobile node at step 503, the mobile node goes to step 534 to terminate a session setup procedure.

The mobile node receiving the session setup request message at step 504 transmits a session setup permission standby message to the source mobile node for transmitting the received session setup request message, such that the mobile node can answer the session setup request message.

The mobile node compares its own IP address with a session-setup-requested mobile node's IP address contained in the received session setup request message at step 506. A representative example of the IP address is shown in Table 1. If the IP address of the session-setup-requested mobile node is equal to the IP address of the mobile node at step 506, the mobile node goes to step 528. If one mobile node has the same IP address as that of the session-setup-requested mobile node, this mobile node is called a destination mobile node. The destination mobile node will be described hereinafter. If the IP address of the session-setup-requested mobile node is not equal to that of the mobile node, the mobile node goes to step 508 and is called a message relay mobile node.

The message relay mobile node stores the received session setup request message at step 508. The message relay mobile node increases the number of transmission/retransmission times of the received session setup request message by one at step 510. That is, the message relay mobile node increases the number N of transmission/retransmission times stored in the received session setup request message by one according to a prescribed equation ‘N=N+1’, and transmits the increased number ‘N+1’ of transmission/retransmission times to a nearby mobile node.

The message relay mobile node compares the increased number ‘N+1’ of transmission/retransmission times with the maximum number of transmission times at step 512. Upon receiving the result of the comparison, if the increased number of transmission/retransmission times is less than the maximum number of transmission times at step 512, the message relay mobile node goes to step 514. Otherwise, if the increased number of transmission/retransmission times is the same or higher than the maximum number of transmission times at step 512, the message relay mobile node goes to step 516. The aforementioned procedure is performed for substantially the same reasons as in FIG. 4.

The message relay mobile node clears the session setup request message stored in the SIP client at step 516, and goes to step 534 to terminate a session setup procedure.

The message relay mobile node transmits the session setup request message to a nearby message relay mobile node at step 514. As stated above, the session setup request message transferred to the message relay mobile node includes information indicating the increased number (i.e., N+1) of transmission/retransmission times as compared with the number N of the received transmission/retransmission times. It is determined at step 518 whether the message relay mobile node has received the session setup permission standby message before the link retransmission timer is expired. If the session setup permission standby message is not transmitted to the message relay mobile node before the link retransmission timer is expired, the message relay mobile node determines that undesired errors have occurred in association with the transmitted session setup request message. Therefore, if the session setup permission standby message is not transmitted to the message relay mobile node before the link retransmission timer is expired, the message relay mobile node goes to step 510, such that it increases the number of transmission/retransmission times by one at step 514. If the session setup permission standby message is transmitted to the message relay mobile node before the link retransmission timer is expired, the message relay mobile node goes to step 520.

The message relay mobile node receives a session setup permission message from a nearby mobile node transmitting the session setup request message at step 520. The message relay mobile node transmits the received session setup permission message to a mobile node receiving a session setup request message at step 522.

The message relay mobile node receives an ACK message from the mobile node transmitting the session setup permission message at step 524. The message relay mobile node transmits the received ACK message to the nearby mobile node at step 526, and goes to step 534 to terminate the above session setup procedure.

The destination mobile node will now be described. The destination mobile node transmits the session setup permission message to the mobile node previously transmitting the session setup request message at step 528. The destination mobile node receives the ACK message at step 530, and goes to step 534 to terminate the session setup procedure. By executing the steps 400 to 534 shown in FIG. 5, the session can be established between the source mobile node and the destination mobile node.

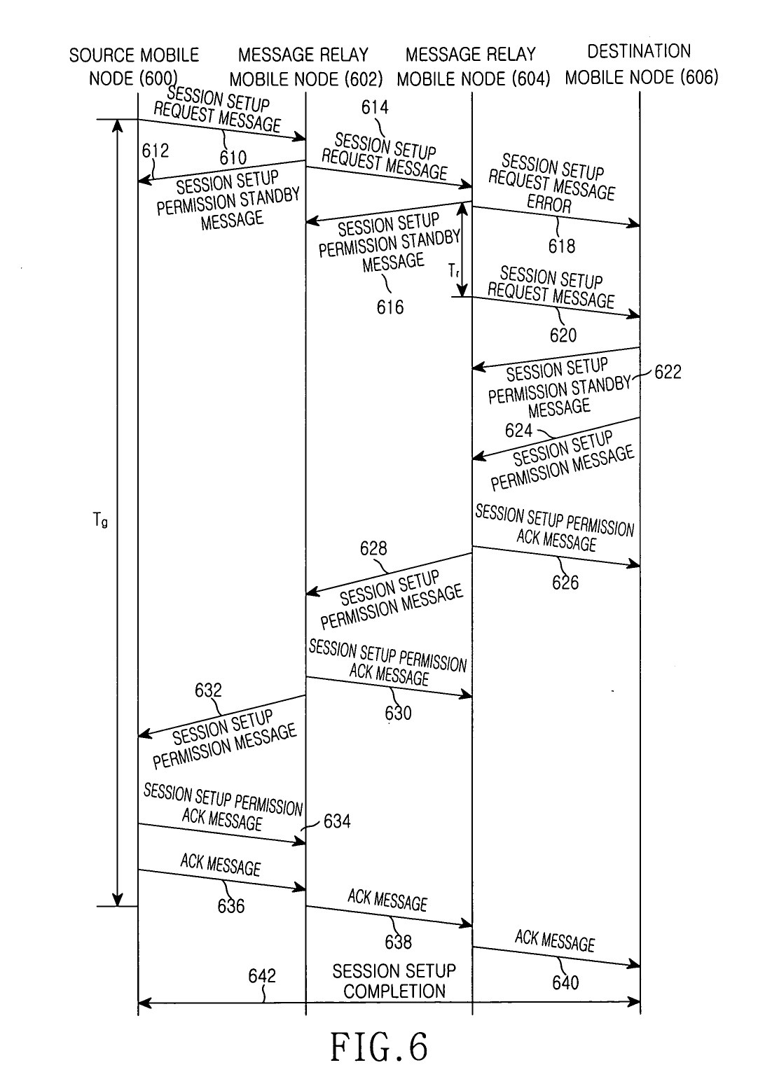

FIG. 6 is a flow chart illustrating an example of a session setup procedure among the source mobile node, the message relay mobile nodes, and the destination mobile node. The aforementioned session setup procedures shown in FIGS. 4 and 5 are integrated into one drawing, i.e., FIG. 6. The session setup procedure shown in FIG. 6 will be described hereinafter.

Referring to FIG. 6, the source mobile node establishes a session to the destination mobile node via two message relay mobile nodes. The source mobile node 600 transmits the session setup request message to the message relay mobile node 602 in order to transmit a session setup request message to the destination mobile node 602 at step 610. The message relay mobile node 602 transmits the session setup permission standby message to the source mobile node 600 at step 612.

The message relay mobile node 602 transmits the session setup request message to the message relay mobile node 604 at step 614. However, the transmitted session setup request message indicates that errors have occurred while being transmitted to the destination mobile node 606. If the link retransmission timer is expired, the message relay mobile node 604 retransmits the session setup request message to the destination mobile node 606 at step 620. The session setup request message at step 620 includes information indicating the increased number (i.e., N+1) of transmission/retransmission times as compared with the number of N of the prior session setup request message at step 618.

The destination mobile node 606 transmits the session setup permission standby message to the message relay mobile node 604 at step 622. The destination mobile node 606 determines that the source mobile node 600 is a mobile node that has transmitted the session setup request message, and transmits the session setup permission message to the message relay mobile node 604 at step 624. The message relay mobile node 604 transmits the session setup permission ACK message to the destination mobile node 606 at step 626. The session setup permission ACK message determines whether errors occur during a transmission time of the session setup permission message. If errors arise during this transmission time, the session setup permission ACK message can recognize these errors in link units.

The message relay mobile node 604 transmits the session setup permission message to the message relay mobile node 602 at step 628. The message relay mobile node 602 transmits the session setup permission ACK message to the other message relay mobile node 604 at step 630.

The message relay mobile node 602 transmits the session setup permission message to the source mobile node 600 at step 632. The source mobile node 600 transmits the session setup permission ACK message to the message relay mobile node 602 at step 634. The source mobile node 600 transmits an ACK message to the message relay mobile node 602 at step 636.

The message relay mobile node 602 transmits the ACK message to the message relay mobile node 604 at step 638. The message relay mobile node 604 transmits the ACK message to the destination mobile node 606 at step 640. Therefore, the session setup procedure between the source mobile node 600 and the destination mobile node 600 is completed at step 642.

As apparent from the above description, the embodiments of the present invention can provide an apparatus and method for quickly recognizing errors created during a session setup time, and quickly performing a session setup process upon receiving the recognized result.

Although embodiments of the present invention have been disclosed for illustrative purposes, those skilled in the art will appreciate that various modifications, additions and substitutions are possible, without departing from the scope and spirit of the invention as set forth in the accompanying claims.

What is claimed is:

1. A method for controlling a source mobile node to establish a session to a destination mobile node via message relay mobile nodes in a radio network comprised of the source mobile node, the destination mobile node, and one or more message relay mobile nodes, comprising the steps of:
(a) creating a session setup request message to be transmitted to the destination mobile node, storing the created session setup request message, and at the same time transmitting the created session setup request message to one message relay mobile node from among the message relay mobile nodes; and
(b) if a session setup permission standby message corresponding to the session setup request message is not received from the message relay mobile node having transmitted the session setup request message before a predetermined link retransmission time elapses, re-transmitting the stored session setup request message.

2. The method as set forth in claim 1, wherein the session setup request message includes a number of link-unit transmission times.

3. The method as set forth in claim 2, further comprising the step of:
(c) if a maximum number of link-unit transmission times is determined, and the number of link-unit transmission times reaches the determined maximum number of link-unit transmission times, deleting the stored session setup request message.

4. The method as set forth in claim 3, wherein the maximum number of link-unit transmission times is calculated using a Round Trip Delay Time (RTDT) between the source mobile node and the destination mobile node and a link retransmission time.

5. The method as set forth in claim 1, further comprising the step of:
(d) if a session setup permission message associated with the session setup request message is not received from the message relay mobile node until a global retransmission time elapses, re-transmitting the stored session setup request message.

6. A method for controlling a message relay mobile node to route a session setup state in a direction from a source mobile node to the destination mobile node at which a session setup request is to be transmitted, in a radio network comprised of the source mobile node, the destination mobile node, and one or more message relay mobile nodes, comprising the steps of:
(a) storing the received session setup request message, and transmitting the stored session setup request message to either the message relay mobile node or the destination mobile node; and
(b) if a session setup permission standby message corresponding to the session setup request message is not received from the mobile node having transmitted the session setup request message before a predetermined link retransmission time elapses, re-transmitting the stored session setup request message.

7. The method as set forth in claim 6, wherein the session setup request message includes a number of link-unit transmission times.

8. The method as set forth in claim 7, further comprising the step of:
(c) if a maximum number of link-unit transmission times is determined, and the number of link-unit transmission times reaches the determined maximum number of link-unit transmission times, deleting the stored session setup request message.

9. The method as set forth in claim 8, wherein the maximum number of link-unit transmission times is calculated using a Round Trip Delay Time (RTDT) between the source mobile node and the destination mobile node and a link retransmission time.

10. The method as set forth in claim 6, further comprising the step of:
(d) if the destination mobile node receives the session setup request message, transmitting the session setup permission message corresponding to the session setup request message to a mobile node having transmitted the session setup request message.

11. The method as set forth in claim 10, wherein the session setup permission message is transmitted to the source mobile node by sequentially passing through the message relay mobile nodes.

12. An apparatus for establishing a session from a source mobile node to a destination mobile node via message relay mobile nodes in a radio network, comprising:
a source mobile node for storing a session setup request message simultaneously transmitting it to the message relay mobile node, and re-transmitting the stored session setup request message when a session setup permission standby message associated with the transmitted session setup request message is not received before a predetermined link retransmission time elapses;
one or more message relay mobile nodes for transmitting a session setup permission standby message to a mobile node having transmitted the session setup request message, transmitting the received session setup request message to another message relay mobile node or the destination mobile node, and re-transmitting the stored session setup request message when a session setup permission standby message associated with the session setup request message is not received before a predetermined link retransmission time elapses; and
a destination mobile node for transmitting the session setup permission standby message associated with the received session setup request message.

13. The apparatus as set forth in claim 12, wherein the source mobile node or the message relay mobile node includes a number of link-unit transmission times in the session setup request message.

14. The apparatus as set forth in claim 13, wherein the destination mobile node having transmitted the session setup permission standby message transmits the session setup permission message to a mobile node having transmitted the session setup permission standby message.

15. The apparatus as set forth in claim 14, wherein the message relay mobile node sequentially transmits the received session setup permission message to the source mobile node.

16. The apparatus as set forth in claim 13, wherein the message relay mobile node deletes the stored session setup request message if the number of link-unit transmission times reaches a maximum number of link-unit transmission times.

17. The apparatus as set forth in claim 16, wherein the source mobile node calculates the maximum number of link-unit transmission times using a Round Trip Delay Time (RTDT) between the source mobile node and the destination mobile node and a link retransmission time.

18. The apparatus as set forth in claim 12, wherein the source mobile node, if a session setup permission message associated with the session setup request message is not received from the message relay mobile node until a global retransmission time elapses, re-transmits the stored session setup request message.

19. The apparatus as set forth in claim 18, wherein the message relay mobile node sequentially transmits the session setup permission message received from the destination mobile node to the source mobile node.
